(19) United States
(12) Patent Application Publication
(10) Pub. No.: US 2025/0306438 A1
(43) Pub. Date: Oct. 2, 2025

(54) Installation Seat for Quick-Installation Plate and Camera Quick-Hanging Member

(71) Applicant: PGYTECH CO.,LTD, Jiangsu (CN)

(72) Inventors: Bingchao XIA, Jiangsu (CN); Xiuzhi YU, Jiangsu (CN)

(73) Assignee: PGYTECH CO.,LTD, Jiangsu (CN)

(21) Appl. No.: 19/031,386

(22) Filed: Jan. 18, 2025

(30) Foreign Application Priority Data
Apr. 1, 2024 (CN) 202420649499.8

(51) Int. Cl. G03B 17/56; F16M 11/04

(52) U.S. Cl. CPC G03B 17/561; F16M 11/041

(57) ABSTRACT

The present disclosure provide an installation seat of a quick-installation plate and a camera quick-hanging member, wherein that installation seat for a quick-installation plate comprise an installation seat, and an assembly cavity and an installation cavity are respectively formed on the upper side and the lower side of the installation seat; a locking part, a sliding part and a trigger part are arranged in the installation cavity, and the trigger part drives the sliding part to move while driving the locking part to move, so that the quick-installation plate can be locked or unlocked.

### CROSS-REFERENCE TO RELATED APPLICATIONS

This application claims the priority of China Patent Application No. 202420649499.8, filed on Apr. 1, 2024, entitled “Installation Seat for Quick-installation Plate and Camera Quick-hanging member”, all the contents and amendments of which are incorporated into this application by reference.

### TECHNICAL FIELD

The present disclosure relates to the technical field of camera assembly, particularly to an installation seat for a quick-installation plate and a camera quick-hanging member.

### BACKGROUND

Camera is a kind of equipment that uses the principle of optical imaging to form and record images. When it is widely used in daily life, many accessories are derived for facilitating the carrying and using of the camera, such as the installation plate of the camera. In the existing installation plate, when the shooting components are fixed, block components are added for fixing. Quick-installation components generally include quick-installation installation seats and quick-installation plates. Due to different manufacturers, the quick-installation plates produced are different. However, in the prior art, there are few adjustments for the quick-installation plates on the installation seats, which limits the assembly thereof in that they can only be installed in one-to-one correspondence.

The existing U.S. Pat. No. 14,545,772 discloses an “A Quick Release Cameran installation System”. This patent designs a base for connecting the camera to an object such as a tripod, a backpack belt or a belt, and can quickly release the adapter from the camera bracket. However, due to the fixed shape of its receiver, it cannot adapt to cameras of various sizes, and thus is inconvenient to use.

Therefore, there is a need to put forward an adjustable camera mount to adapt to more quick-installation plates.

### SUMMARY

An object of the present disclosure is to provide an installation seat for a quick-installation plate and a camera quick-hanging member, which act on a trigger part during assembly, and then drive a sliding part and a locking part to move in different directions, thus occupying less space. In addition, this movement mode can complete the disassembly and installation of the quick-installation plate without adding other redundant structures in the assembly cavity, which makes it more adaptable to the quick-installation plate and expands its application range.

In order to achieve the above object, the present disclosure is realized by the following technical solution.

An installation seat for a quick-installation plate includes an installation seat, wherein an assembly cavity and an installation cavity are respectively formed on an upper side and a lower side of the installation seat, wherein the installation cavity is internally provided with a locking part that moves close to or away from the assembly cavity along the installation cavity, a sliding part linked with the locking part, and a trigger part that contacts with the sliding part; and when moving in a first horizontal direction, the trigger part drives the sliding part to move in a second horizontal direction, and at the same time, the locking part linked with the sliding part moves up and down to be close to or away from the assembly cavity for locking or unlocking the quick-installation plate located in the assembly cavity.

The present disclosure further provides a camera quick-hanging member, including the above installation seat for a quick-installation plate and the quick-installation plate assembled through a shell of the installation seat for a quick-installation plate, wherein the shell of the installation seat for a quick-installation plate is partially inserted into the locking part, and the locking or unlocking of the quick-installation plate is realized during the lifting of the locking part.

### BRIEF DESCRIPTION OF DRAWINGS

The drawings, which constitute a part of this application, are used to provide a further understanding of the present disclosure. The illustrative embodiments of the present disclosure and the description thereof are used to explain the present disclosure, and do not constitute undue limitations on the present disclosure. In the drawings:

FIG. 1 is a front view of an installation seat of a quick-installation plate provided by the present disclosure in a locked state;

FIG. 2 is a schematic view of the internal structure of the locking part and the sliding part when the installation seat for a quick-installation plate in FIG. 1 is locked;

FIG. 3 is a schematic sectional view of the locked state of the installation seat for a quick-installation plate in FIG. 1;

FIG. 4 is a schematic structural view of the installation seat for a quick-installation plate in FIG. 1 in an unlocked state;

FIG. 5 is a schematic diagram of the internal structure of the locking part, the sliding part and the trigger part when the installation seat for a quick-installation plate in FIG. 1 is unlocked;

FIG. 6 is a schematic cross-sectional view of the installation seat for a quick-installation plate in FIG. 1 in an unlocked state;

FIG. 7 is a schematic structural diagram of the camera quick-hanging member provided by the present disclosure;

FIG. 8 is one of the schematic sectional views of the quick-hanging member in FIG. 7;

FIG. 9 is the second schematic sectional view of the quick-hanging member in FIG. 7;

FIG. 10 is a schematic diagram of the overall structure of another embodiment of the present disclosure;

FIG. 11 is one of the schematic diagrams of the internal structure of the quick-hanging member in FIG. 10;

FIG. 12 is the second schematic diagram of the internal structure of the quick-hanging member in FIG. 10;

FIG. 13 is a schematic sectional view of the quick-hanging member in FIG. 10.

The above drawings include the following reference signs:
Installation seat (100); Locking part (110); Locking member (111); Locking reset member (112); Sliding part (120); Slider (121); Button (122); Button reset member (123); Screw (124); Limiting member (125); Trigger part (130); Trigger member (131); Compression member (132); Enclosure cavity (133); Guide surface (134); Assembly cavity (140); Installation cavity (150); Wedge (160); Driving member (170); Quick-installation plate (200); Quick-installation plate Installation seat shell (300).

### DESCRIPTION OF EMBODIMENTS

The technical solution in the embodiment of the present disclosure will be clearly and completely described below with reference to the drawings. Obviously, the described embodiment is part of, rather than all of the embodiments of the present disclosure. The following description of at least one exemplary embodiment is illustrative in nature and is in no way intended to limit the present disclosure, its application or uses. Based on the embodiments in the present disclosure, all other embodiments obtained by those skilled in the art without creative work belong to the scope of protection of the present disclosure.

It should be noted that the terminology used here is only for describing specific embodiments, and is not intended to limit exemplary embodiments according to the present application. As used herein, the singular form is also intended to include the plural form unless the context clearly indicates otherwise. Furthermore, it should be appreciated that when the terms “comprising” and/or “including” are used in this specification, they specify the presence of features, steps, operations, devices, components and/or combinations thereof.

Unless otherwise specified, the relative arrangement of components and steps, numerical expressions and numerical values set forth in these embodiments do not limit the scope of the present disclosure. At the same time, it should be appreciated that for the convenience of description, the dimensions of various parts shown in the drawings are not drawn according to the actual scale relationship. Techniques, methods and equipment known to those skilled in the art may not be discussed in detail, but in appropriate cases, they should be regarded as part of the authorization specification. In all the examples shown and discussed herein, any specific values should be interpreted as illustrative, and not as limiting. Therefore, other examples of exemplary embodiments may have different values. It should be noted that similar numbers and letters indicate similar items in the following drawings, therefore once an item is defined in one drawing, it does not need to be further discussed in subsequent drawings.

### Embodiment 1

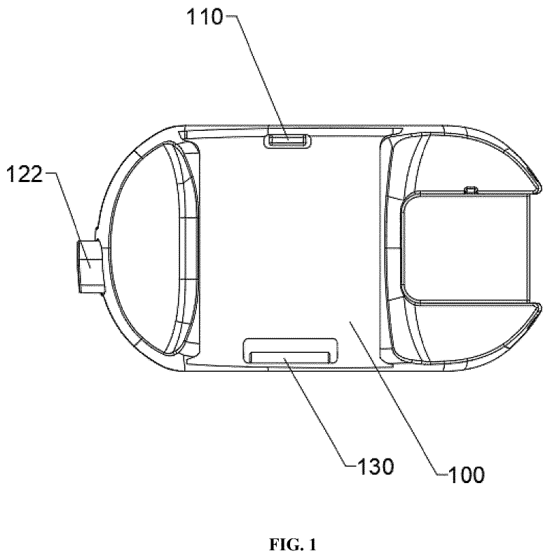

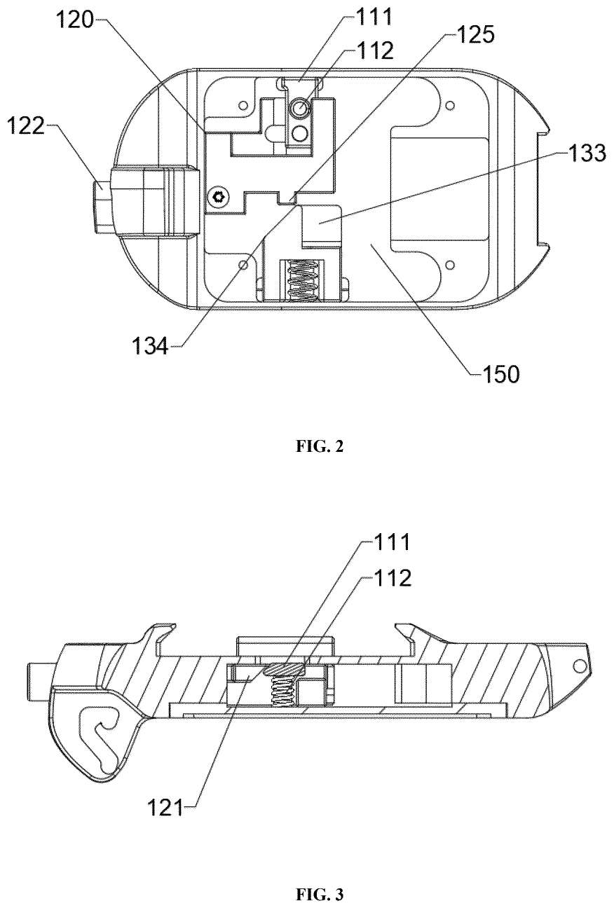

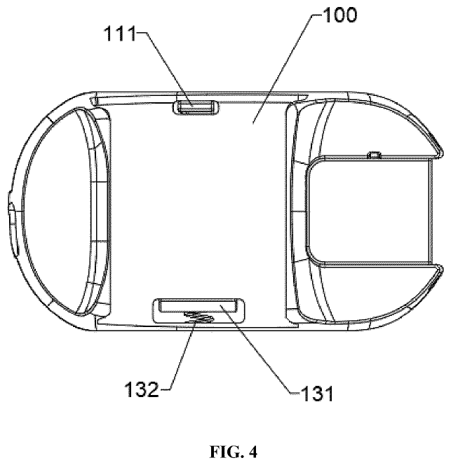

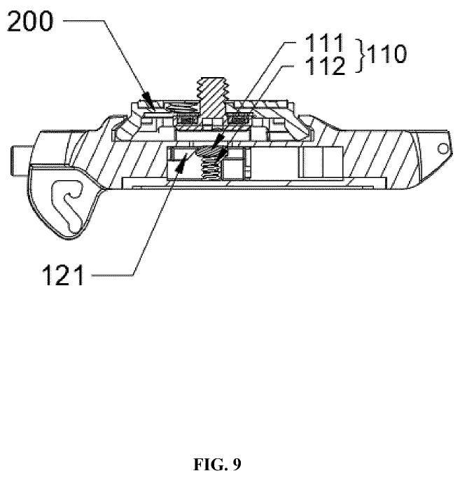

Referring to FIG. 1-9, the installation seat for a quick-installation plate in this embodiment includes an installation seat 100, and the upper and lower sides of the installation seat 100 respectively form an assembly cavity 140 and an installation cavity 150, that is, the assembly cavity 140 and the installation cavity 150 are arranged in reverse, one for the assembly of the quick-installation plate 200 and the other for the installation of other structural parts. Specifically, in this embodiment, a locking part 110 is arranged in the installation cavity 150. In this embodiment, the locking part 110 can move along the installation cavity 150 to be close to or away from the installation cavity 140. The locking part 110 is also linked with a sliding part 120, and the sliding part is in contact with a trigger part 130. When the trigger part 130 is triggered by an external force, it moves close to or away from the installation in the first horizontal direction to drive the sliding part 120 to move in the second horizontal direction (i.e. a direction perpendicular to the first horizontal direction), and synchronously make the locking part 110 linked with the sliding part 120 move up and down while getting close to or away from the assembly cavity 150, so as to lock or unlock the quick-installation plate 200 located in the assembly cavity 150.

In this embodiment, compared with the rotating mode in the prior art, the locking part 110 is extended or retracted directly by lifting, so that the locking and unlocking of the quick-installation plate can be quickly completed, which is simpler and faster in operation and more convenient in use.

In this embodiment, the periphery of the installation seat 100 extends to form a frame, and each component is assembled in the frame to avoid protruding outwards. The following is a further detailed introduction of each structure in the installation seat.

First, the description of the sliding part 120 is as follows.

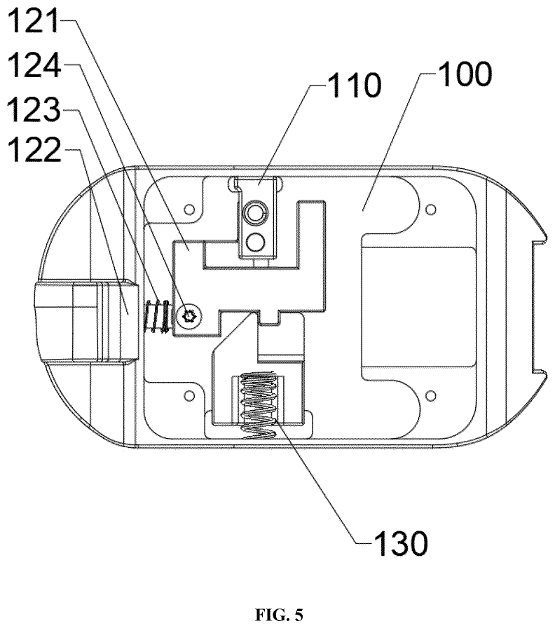

Referring to FIG. 5, it can be seen that the sliding part 120 is arranged along the length direction of the installation seat 100, while the locking part 110 and the trigger part 130 are located at the two sides of the sliding part 120. In this case, less space is occupied, the components will affect each other in the whole process of movement, and the sliding part 120 synchronously forms the limit for the trigger part 130. At this time, the sliding part 120 extends towards the trigger part 130 to form a limiting member 125 contacting with the trigger part, and the limiting member 125 contacts with the trigger part 130. At this time, the limiting member 125 and the trigger part 130 have two states, one being that the limiting member moves along the trigger part, and the other being that the limiting member is clamped on the trigger part 130 when locked. The detailed movement process will be introduced later.

On the side of the sliding part 120 far away from the limiting member, a slider 121 is formed. The slider 121 is in contact with the locking part 110. When the sliding part 120 slides in the second direction, specifically, the locking part 110 is driven up and down by the slider 121.

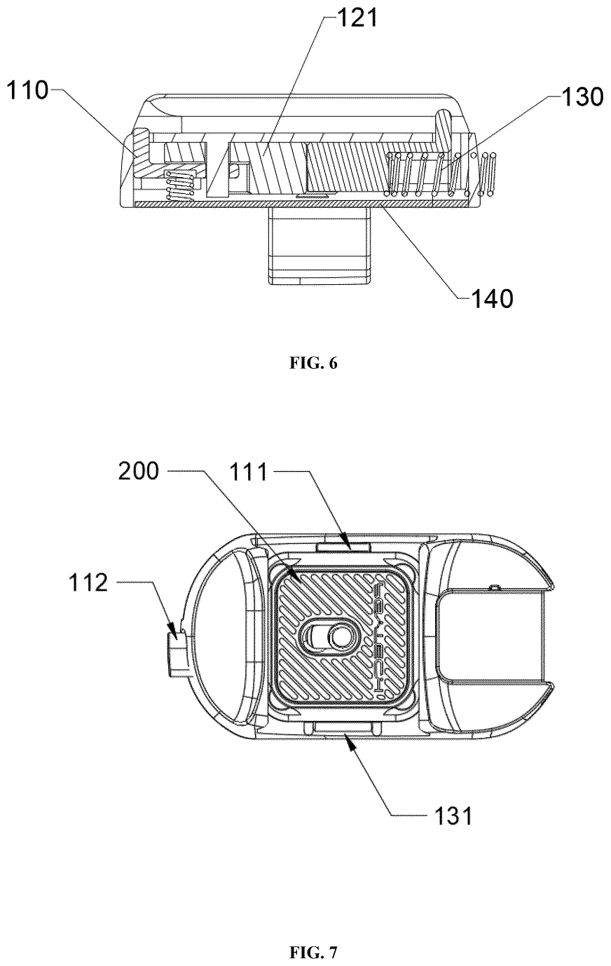

Referring to FIG. 6, it can be seen that the slider 121 forms an inclined sliding guide trajectory, and the locking part moves within this trajectory range. In this inclined movement, the locking part 110 is lifted up and down.

In this embodiment, a button 122 and a button reset member 123 are also arranged in the horizontal second direction. The button reset member is sleeved on the button 122 and connected with the whole end of the slider 120 through a screw 124. At this time, by pressing the button 122, the sliding part 120 can move in the second direction, and then get close to the trigger part 130. In this process, the trigger part 130 is blocked, and the locking part 110 moves towards the installation cavity 150, thus realizing unlocking.

Secondly, the specific introduction of the trigger part is as follows.

With reference to FIG. 6, it can be seen that in order to realize the movement along the sliding part 120 and the locking of the slider 121 in the sliding part 120, the trigger part 130 further forms an enclosure cavity 133 on the side far away from the button. The enclosure cavity 133 forms a semi-enclosure structure, and then forms a guide surface 134 towards the button 122 in the reverse direction of the semi-enclosure. Thereby, when the trigger part 130 is triggered, the sliding part 120 moves along the guide surface towards the button. When sliding part 120 moves away from the button after the button is pressed, the limiting member 125 moves along the guide surface 134 and passes over the guide surface 134 to be locked in the enclosure cavity 133 at the side of the guide surface 134. After being unlocked, the trigger part 130 will move towards the frame, and then the enclosure cavity 133 will retreat away from the sliding part 120.

At a position where the trigger part 130 is far away from the sliding part 120, the trigger member 131 forms a limiting cavity, and a compression part 132 located in the limiting cavity is abutted against the installation seat 100 in a compressed state. At this time, the compression member 132 is already in a compressed state, and when the trigger part is triggered, the compression is intensified, and then the trigger part 130 at this time can hold the quick-installation plate 200 well. In this embodiment, the trigger part 130 partially extends out of the installation cavity and enters the assembly cavity, and forms a clamping cavity with the extended locking part 110 to fix the quick-installation plate.

Thirdly, the locking part in this embodiment is described as follows.

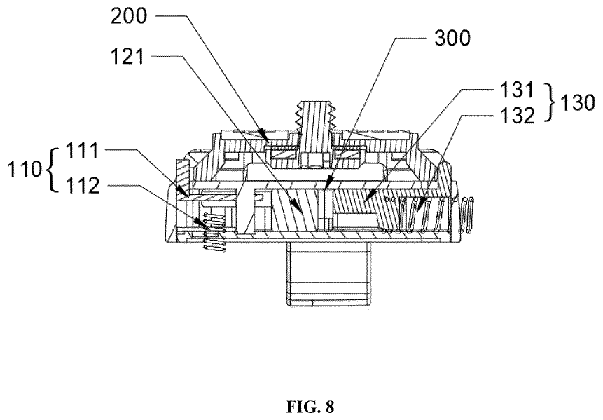

Referring to FIG. 8, in this embodiment, the locking part 110 includes a locking member 111 with an L-shaped structure, and the locking member 111 is connected with a locking reset part 112 which drives the locking member 111 to reset. When the L-shaped locking member 111 is close to the assembly cavity, one side of the locking member 111 forms a locking mechanism, while the other side is connected with the locking reset part 112, which can be linked by the sliding part 120 to perform the whole lifting movement, so that the locking mechanism can extend out or retreat from the assembly cavity 140 to realize locking or unlocking.

When the present disclosure is used, due to the addition of many inclined planes, the linkage effect is good and easy to control. The specific process is as follows:
when it is necessary to lock the quick-installation plate, the quick-installation plate 200 enters the assembly cavity 140, and then contacts the trigger part 130 extending into the assembly cavity, so that it is forced to move outwards; due to the existence of the compression part 132 in the trigger part 130, the compression is further increased, which means that the trigger part 130 retreats outwards, and then the limiting member 125 previously located in the enclosure cavity 133 contacts the guide surface 134 on the other side of the enclosure cavity 133, whereby the limiting member 125 moves in the direction close to the button along the guide surface; but due to the limitation of the length of the guide surface and the limitation of the whole sliding part 120, the limiting member 125 can only move in the set second direction range; at this time, the slider 121 is also driven to move in the direction close to the button, which in turn drives the locking member 111 to move upward, and then the locking part is lifted up to clamp the quick-installation plate with the compressed trigger part.

For unlocking, the button 122 is pressed to make the sliding part 120 move away from the button 122. When moving to a certain position, the whole guide surface 134 passes through the slider 121, and then the slider 121 is clamped into the enclosure cavity 133. In this embodiment, both the enclosure cavity 133 and the slider 121 are quadrangular structures. At this time, due to the whole inward movement of the sliding part, the slider 121 also moves inward along the sliding guide track, so that the locking member 111 moves downward, squeezing the locking reset part, and the locking part moves downward to realize unlocking. After the quick-installation plate is removed, all the forces disappear, and then the compressed part 132 in the trigger part 130 is in a compressed state, and the compressed locking reset part 112 is reset, so that the locking part 110 faces upward. After the button 122 is reset, it extends out of the frame of the installation seat 100 again. Specifically, the button 122 passes through the frame and moves along the bezel in the installation cavity.

Referring to FIGS. 7-9, in this embodiment, a camera quick-hanging member is also disclosed, which includes the above-mentioned installation seat for a quick installation plate and the quick installation plate 200 assembled by a quick installation plate installation seat shell 300. The quick installation plate installation seat shell 300 is partially inserted into the locking part 110 and locks or unlocks the quick installation plate 200 during the lifting of the locking part 110.

In this embodiment, the camera quick-hanging member is synonymous with the installation structure for quick installation of a camera. Specifically, both the trigger part and the sliding part form the same horizontal contact surface, and the quick installation plate installation seat shell 300 is always in contact with this horizontal contact surface, so that when the locking part 110 is lifted up, the quick installation plate installation seat shell 300 and the quick-installation plate are locked, while when the locking part 110 is lowered, the quick installation plate installation seat shell 300 and the quick-installation plate 200 are exposed for easy disassembly.

### Embodiment 2

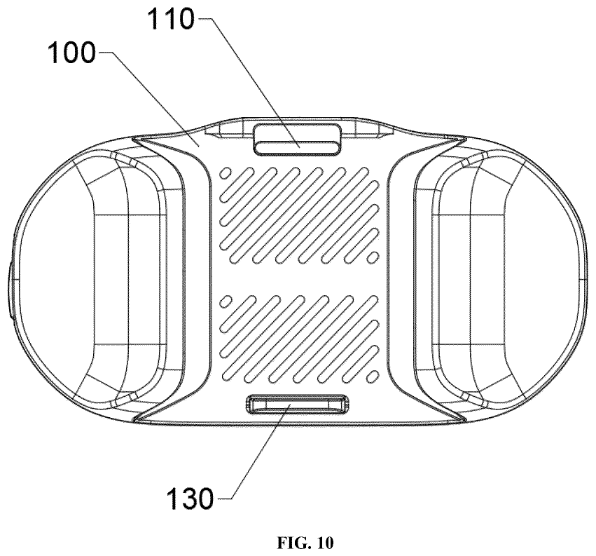

Referring to FIGS. 10-13, the installation seat 100 of the quick-installation plate in this embodiment includes the installation seat 100. An assembly cavity 140 and an installation cavity 150 are respectively formed on the upper and lower sides of the installation seat. The installation cavity 150 is provided with a locking part 110 moving close to or away from the assembly cavity 140 along the installation cavity 150, a sliding part 120 linked with the locking part 110, and a trigger part 130 contacting with the sliding part 120.

When the trigger part 130 moves in the first horizontal direction, it drives the sliding part 120 to move in the second horizontal direction. At the same time, the locking part 110 linked with the sliding part 120 moves up and down while getting close to or away from the assembly cavity 140 for locking or unlocking the quick-installation plate located in the assembly cavity 140.

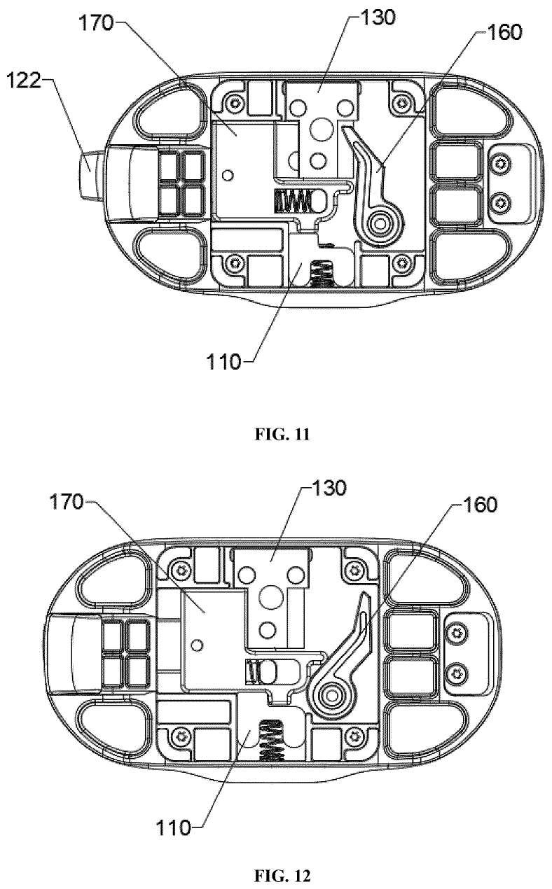

With reference to FIG. 11, a wedge 160 is rotatably arranged in the installation seat 100, the wedge is rotatably connected with the installation seat 100, and the wedge 160 can be used for clamping the locking part 110.

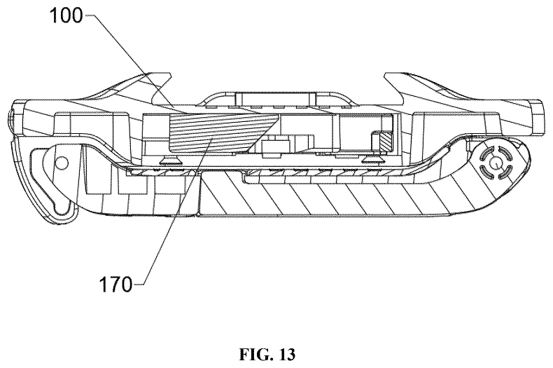

With reference to FIG. 13, a driving block 170 is slidably arranged in the installation seat 100. The driving block 170 is fixedly connected with the button 122. The driving block 170 is provided with an inclined plane for pressing down the locking block, and the middle part of the driving block is provided with a yielding groove.

In this embodiment, when the camera quick-installation plate is installed, the trigger member 131 is pushed down from the trigger part 130 to slide in. After contacting the locking part 110, the locking member 111 is pushed to slide to unlock the driving member 170. At the same time, as the driving member 170 is unlocked and moves away from the wedge 160, the wedge 160 is reset. At this time, the a quick-installation plate has slid to the appropriate position of the installation plate 100. The reset of the wedge 160 means that the wedge 160 rotates below the trigger part 130 to lock the trigger part 130, so that the quick-installation plate can be stably installed on the installation seat 100, and the quick-installation plate can be quickly installed and disassembled on the installation seat 100.

From the above description, it can be seen that the above-mentioned embodiment of the present disclosure has achieved the following technical effects: in this embodiment, compared with the prior art, the whole horizontal movement is carried out in the installation cavity, while only the locking part and the trigger part are moved in the assembly cavity, one realizing locking by lifting, and the other realizing clamping or loosening matched with the locking part through horizontal movement, so that the quick-installation plate can be assembled quickly, and the whole process is simple; in the whole process, the components are linked with each other while restricted by each other, so that they can carry out related movements within the set safety range to complete locking and unlocking.

In the present disclosure, symmetrical clamping plates, such as dovetail-groove-shaped clamping plates, can also be arranged in the same first direction as the locking part or in the second direction of assembling the button, so as to cooperate with the locking part, so that the assembling firmness of the quick-assembling plate is better.

In the description of the present disclosure, it should be appreciated that the orientation or positional relationship indicated by orientation words such as “front, back, upper, lower, left, right”, “lateral, vertical, horizontal” and “top, bottom” are usually based on the orientation or positional relationship shown in the attached drawings, just for the convenience of describing the present disclosure and simplifying the description. Unless otherwise stated, these orientation words do not indicate or imply that the device or element referred to must have a specific orientation or be constructed and operated in a specific orientation, therefore they cannot be construed as limiting the scope of protection of the present disclosure. The orientation words “inside and outside” refer to the inside and outside relative to the outline of each component itself.

For the convenience of description, spatially relative terms such as “above”, “on”, “on the upper surface of” and “upper” can be used here to describe the spatial positional relationship between a device or feature as shown in the drawings and other devices or features. It should be appreciated that spatially relative terms are intended to encompass different orientations in use or operation in addition to the orientation of the device depicted in the drawings. For example, if the devices in the drawings are inverted, devices described as “above” or “on” other devices or structures will be positioned as “below” or “under” other devices or structures. Thus, the exemplary term “above” can include both orientation of “above” and “below”. The device can also be positioned in other different ways (rotated by 90 degrees or in other orientations), and the spatial relative description used here is explained accordingly.

In addition, it should be noted that the words “first” and “second” are used to define parts for the convenience of distinguishing the corresponding parts. Unless otherwise stated, the above words have no special meaning, and thus they cannot be construed as limiting the protection scope of the present disclosure.

What has been described above is only the preferred embodiment of the present disclosure, and it is not intended to limit the present disclosure. For those skilled in the art, the present disclosure may have various modifications and changes. Any modification, equivalent substitution, improvement and the like made within the spirit and principle of the present disclosure shall fall into the protection scope of the present disclosure.

What is claimed is:

1. An installation seat for a quick-installation plate, comprising an installation seat, wherein an assembly cavity and an installation cavity are respectively formed on an upper side and a lower side of the installation seat, wherein
the installation cavity is internally provided with a locking part that moves close to or away from the assembly cavity along the installation cavity, a sliding part linked with the locking part, and a trigger part that contacts with the sliding part; and
when moving in a first horizontal direction, the trigger part drives the sliding part to move in a second horizontal direction, and at the same time, the locking part linked with the sliding part moves up and down to be close to or away from the assembly cavity for locking or unlocking the quick-installation plate located in the assembly cavity.

2. The installation seat for a quick-installation plate according to claim 1, wherein
the sliding part extends towards the trigger part to form a limiting member which contacts with the trigger part and moves along the trigger part.

3. The installation seat for a quick-installation plate according to claim 2, wherein
the trigger part comprises an enclosure cavity for an enclosing the limiting member, and a guide surface contacting with the limiting member and driving the limiting member to move is formed outside the enclosure cavity.

4. The installation seat for a quick-installation plate according to claim 3, wherein
the trigger part forms a limiting cavity, and a compression member located in the limiting cavity is abutted against the installation seat in a compressed state.

5. The installation seat for a quick-installation plate according to claim 1, wherein
a side of the sliding part opposite to the trigger part form a slider which is in surface contact with the locking member in the locking part.

6. The installation seat for a quick-installation plate according to claim 5, wherein
an inclined sliding guide track is formed on the sliding member, and the locking member moves along the sliding guide track to be close to or away from the assembly cavity.

7. The installation seat for a quick-installation plate according to claim 1, wherein
a locking reset member connected with the locking member is arranged at a position on a bottom of the installation cavity far from the assembly cavity.

8. The installation seat for a quick-installation plate according to claim 1, wherein
the locking member extends towards the assembly cavity to form a locking mechanism, and during locking or unlocking, the locking mechanism extends out or retreats along the assembly cavity.

9. The installation seat for a quick-installation plate according to claim 1, wherein
the sliding part is connected with a button and a button reset member for controlling the button to reset along the second direction.

10. The installation seat for a quick-installation plate according to claim 1, wherein the installation seat is provided with anti-skid lines.

11. The installation seat for a quick-installation plate according to claim 1, wherein a wedge is rotatably arranged in the installation seat, and the wedge is rotatably connected with the installation seat for clamping the locking part.

12. The installation seat for a quick-installation plate according to claim 9, wherein a driving block is slidably arranged in the installation seat, the driving block is fixedly connected with the button, and an inclined plane for pressing down the locking block is arranged on the driving block.

13. The installation seat for a quick-installation plate according to claim 12, wherein a middle part of the driving block is provided with a yielding groove.

14. The installation seat for a quick-installation plate according to claim 1, wherein the locking part and the trigger part are both provided with rounded corners.

15. A camera quick-hanging member, comprising:
the installation seat for a quick-installation plate as claimed in claim 1, and the quick-installation plate assembled through a shell of the installation seat for a quick-installation plate, wherein the shell of the installation seat for a quick-installation plate is partially inserted into the locking part, and the locking or unlocking of the quick-installation plate is realized during the lifting of the locking part.

16. A camera quick-hanging member, comprising
the installation seat for a quick-installation plate as claimed in claim 11 and the quick-installation plate assembled through a shell of the installation seat for a quick-installation plate, wherein the shell of the installation seat for a quick-installation plate is partially inserted into the locking part, and the locking or unlocking of the quick-installation plate is realized during the lifting of the locking part.
